(19) United States
(12) Patent Application Publication
(10) Pub. No.: US 2012/0264655 A1
(43) Pub. Date: Oct. 18, 2012

(54) THERMO-RESPONSIVE HYDROGELS AND THERMO-RESPONSIVE POLYMER SOLUTIONS

(75) Inventors: Shawn Fitch, Pearland, TX (US); Robert L. Horton, Sugarland, TX (US); Brian L. Mueller, Missouri City, TX (US)

(73) Assignee: CORSICANA TECHNOLOGIES, INC., Houston, TX (US)

(21) Appl. No.: 13/445,201

(22) Filed: Apr. 12, 2012

Related U.S. Application Data
(60) Provisional application No. 61/475,733, filed on Apr. 15, 2011.

(51) Int. Cl. C09K 8/12

(52) U.S. Cl. 507/101; 507/119; 507/120; 507/117; 507/124

(57) ABSTRACT

Polymers and hydrogels that are provided that are thermo-responsive, such as thermo-thickening polymers and hydrogels, as well as aqueous solutions whose rheological properties may be modified by including the polymers, hydrogels, or combinations thereof. Such thermo-responsive polymers or hydrogels, or aqueous solutions including the polymers or hydrogels, may be used as additives to reservoir drilling fluids (RDF's), fluid loss control (FLC) pills, hydraulic fracturing fluids (frac fluids), and lost circulation (LC) pills. The polymers or hydrogels may impart a rheological profile that is generally flat with respect to variations in the shear-rate and temperature environment in which drilling fluids, RDF's, FLC pills, frac fluids, and LC pills are deployed. Embodiments include the process of producing a high performance filtercake through the application of thermo-responsive hydrogels and/or thermo-responsive polymer solutions.

### CROSS-REFERENCE TO RELATED APPLICATIONS

This application claims priority to co-pending U.S. provisional patent application Ser. No. 61/475,733, filed on Apr. 15, 2011.

### BACKGROUND OF THE INVENTION

### Field of the Invention

The present invention relates to thermo-responsive hydrogels and thermo-responsive polymer solutions.

### BRIEF SUMMARY OF THE INVENTION

Embodiments of the present invention include polymers and hydrogels that are thermo-responsive, such as thermo-thickening polymers and hydrogels, as well as aqueous solutions whose rheological properties may be modified by including the polymers, hydrogels, or combinations thereof. Embodiments of the present invention may also include the use of such thermo-responsive polymers or hydrogels, or aqueous solutions including the polymers or hydrogels, as additives to reservoir drilling fluids (RDF's), fluid loss control (FLC) pills, hydraulic fracturing fluids (frac fluids), and lost circulation (LC) pills. Embodiments of the present invention include polymers or hydrogels that impart a rheological profile that is generally flat with respect to variations in the shear-rate and temperature environment in which drilling fluids, RDF's, FLC pills, frac fluids, and LC pills are deployed. Embodiments of the present invention also include the process of producing a high performance filtercake through the application of thermo-responsive hydrogels and/or thermo-responsive polymer solutions. Embodiments of the present invention teach the process of achieving fluid diversion through the application of thermo-responsive hydrogels and/or thermo-responsive polymer solutions.

At the end of the use of thermo-responsive hydrogels and/or thermo-responsive polymer solutions, a chemical break therein is also desired. The chemical break may be due to the application of an external chemical, to the natural breakdown of chemically weak segments deliberately engineered into said thermo-responsive hydrogels and/or polymer solutions, or to the activation of a previously inactive internal breaker chemical.

Embodiments of the present invention teach thermo-responsive polymers that are graft copolymers comprising a water-soluble portion to which linear linkages are grafted at numerous locations along the length of said water-soluble portion. In some embodiments, the present invention teaches thermo-responsive polymers that are graft copolymers comprising a water-soluble portion to which non-linear linkages are grafted. In some embodiments, the present invention teaches such graft copolymers comprising a water-soluble portion which may be either linear or non-linear to which linear or non-linear linkages are grafted. In some embodiments, the present invention teaches thermo-responsive polymers that are graft copolymers having an overall structure that is a comb-like structure with a linear portion or backbone and with linear linkages coming off of it. In some embodiments, the present invention teaches thermo-responsive polymers that are graft copolymers having an overall structure that is a much more complex than the comb-like structure, with a non-linear portion or backbone and with linear or non-linear linkages coming off of it. In some embodiments, the present invention teaches such graft copolymers having linear or non-linear linkages coming off of it such that said pendant linkages possess thermo-responsive or thermo-stimulatable structure or structures that may form a microphase in response to changes in temperature. Other aspects and advantages of the invention will be apparent from the following detailed description and the appended claims.

### BRIEF DESCRIPTION OF THE SEVERAL VIEWS OF THE DRAWINGS

FIG. 1 is a graph of viscosity as a function of temperature that illustrates thermo-thickening for a first polymer having a poly(acrylic acid) backbone and poly(ethylene glycol) functional groups in accordance with Example 1 and a second polymer having a poly(ethylene glycol) backbone and poly(lactide) functional groups in accordance with Example 2.

### DETAILED DESCRIPTION OF THE INVENTION

The invention relates more specifically to the application of such thermo-responsive hydrogels and/or thermo-responsive polymer solutions (such as thermo-thickening hydrogels and/or thermo-thickening polymer solutions) as additives to reservoir drilling fluids (RDF's), fluid loss control (FLC) pills, hydraulic fracturing fluids (Frac Fluids), and lost circulation (LC) pills. In one aspect, the present invention relates specifically to imparting a rheological profile that is generally flat with respect to variations in the shear-rate and temperature environment in which said thermo-responsive hydrogels and/or thermo-responsive polymer solutions are applied as additives to drilling fluids, RDF's, FLC pills, frac fluids, and LC pills. In another aspect, the present invention relates specifically to the process of producing a high performance filtercake through the application of thermo-responsive hydrogels and/or thermo-responsive polymer solutions. In yet another aspect, the present invention relates specifically to the process of achieving fluid diversion through the application of thermo-responsive hydrogels and/or thermo-responsive polymer solutions.

At the end of the use of thermo-responsive hydrogels or polymer solutions, a chemical break therein is also desired. This chemical break may be due to the application of an external chemical, to the natural breakdown of chemically weak segments deliberately engineered into said hydrogels or polymer solutions, or to the activation of a previously inactive internal breaker chemical.

In certain embodiments, the present invention relates to aqueous solutions of thermo-responsive polymers that are graft copolymers comprising a water-soluble portion to which linear linkages are grafted at numerous locations along the length of said water-soluble portion. In some embodiments, the present invention relates to aqueous solutions of thermo-responsive polymers that are graft copolymers comprising a water-soluble portion to which non-linear linkages are grafted. In some embodiments, the present invention relates to such graft copolymers comprising a water-soluble portion which may be either linear or non-linear to which linear or non-linear linkages are grafted. In some embodiments, the present invention relates to aqueous solutions of thermo-responsive polymers that are graft copolymers having an overall structure that is a comb-like structure with a linear portion or backbone and with linear linkages coming off of it. In some embodiments, the present invention relates to aqueous solutions of thermo-responsive polymers that are graft copolymers having an overall structure that is a much more complex than the comb-like structure, with a non-linear portion or backbone and with linear or non-linear linkages coming off of it. In some embodiments, the present invention relates to such graft copolymers having linear or non-linear linkages coming off of it such that said pendant linkages possess thermo-responsive structure or structures that may form a microphase in response to changes in temperature.

Embodiments of the present invention teach additional thermo-thickening and/or thermo-responsive hydrogels and/or thermo-thickening and/or thermo-responsive polymers, such as, for example, a thermo-responsive polymer system prepared by grafting linear poly(ethylene oxide) onto linear, water-soluble poly(acrylic acid). Alternatively, the linear, water-soluble backbone may be poly(acrylamide) and the linear grafts are poly(ethylene oxide-co-propylene oxide).

Embodiments of the present invention teach thermo-thickening and/or thermo-responsive polymers that are graft copolymers comprising a water-soluble portion to which linear linkages are grafted at numerous locations along the length of said water-soluble portion. Examples of such embodiments of the present invention are illustrated with the following structures:

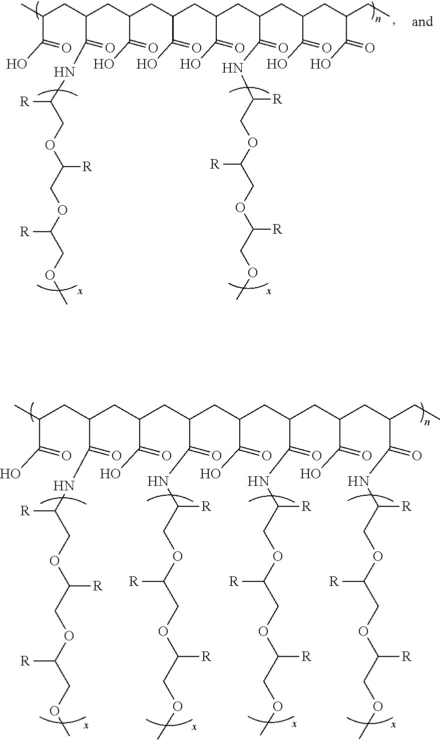

where R=H or CH₃, n ranges from 2 to 100,000, preferably 4 to 1000, and x ranges from 1 to 1000, and preferably from 3 to 100.

Embodiments of the present invention teach additional thermo-thickening and thermo-responsive hydrogels and thermo-thickening and thermo-responsive polymers and additional aqueous solutions whose rheological properties may be modified through the application of thermo-thickening and/or thermo-responsive hydrogels and/or thermo-thickening and/or thermo-responsive polymer solutions. The polymeric graft side-chains are thermally responsive and exhibit a lower critical solution temperature (LCST). As the temperature is increased, these polymer segments become less water-soluble and self-aggregate into microdomains, thereby forming a 3-dimensional, self-associated/crosslinked gel network with a corresponding viscosity increase.

In some embodiments, the present invention teaches thermo-thickening and/or thermo-responsive polymers that are graft copolymers having an overall structure that is a comb-like structure with a linear portion or backbone and with linear linkages coming off of it. Examples of such comb-like structures in accordance with the present invention are illustrated with the following structures:

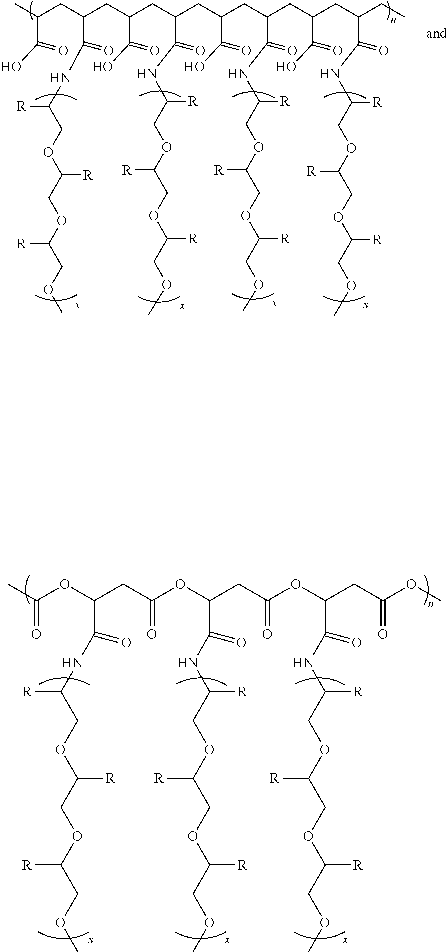

where R=H or CH₃.

Embodiments of the present invention teach the application of such thermo-thickening and/or thermo-responsive hydrogels and/or thermo-thickening and/or thermo-responsive polymer solutions as additives to RDF's. In many cases the viscosity of conventional RDF's decreases with increasing temperature. If a portion of the polymers used to control the rheology of such conventional RDF's were replaced by a small amount of a thermo-thickening and/or thermo-responsive hydrogels and/or thermo-thickening and/or thermo-responsive polymer, then at low temperature the RDF's rheology would be little changed, but at high temperature, its viscosity would be increased a little in comparison with the original conventional RDF. The overall result would be a flattening of rheology over a broad temperature range. The invention disclosed herein would additionally benefit a drilling fluid or an RDF by increasing viscosity upon subjection to geothermal heat and/or heat generated from the action of drilling whereby such increased viscosity will aid in the transportation of cuttings to the surface.

Embodiments of the present invention teach the application of such thermo-thickening and/or thermo-responsive hydrogels and/or thermo-thickening and/or thermo-responsive polymer solutions as additives to FLC pills. Some FLC pills work by inhibiting the seepage of fluid through the filter cake and into areas of the formation with high permeability so that fluid is retained in the wellbore and not lost to the formation. Other FLC pills work by inhibiting the seepage of fluid through the porous medium itself. The invention disclosed herein would add to a FLC pill's efficiency by forming a self-associating gel and the consequent increase in viscosity will act to decrease permeability through the filter cake or the porous medium and seal the formation against any further fluid loss.

Embodiments of the present invention teach the application of such thermo-thickening and/or thermo-responsive hydrogels and/or thermo-thickening and/or thermo-responsive polymer solutions as additives to frac fluids. A frac fluid works by carrying proppant down a wellbore to the desired zone to be stimulated. The fluid is pumped at a rate sufficient enough to overcome the zone's fracture pressure, resulting in the formation of a fracture or fissure. This fracture is then held open by the proppant resulting in a large region of increased surface area and thereby increased conductivity. The frac fluid must be viscous enough to keep the proppant suspended and to have minimal incidental fluid loss not related to the fracturing of the formation. The invention disclosed herein would facilitate the viscosity needed to effectively suspend and transport proppant. The invention disclosed herein would also increase in viscosity as the fluid enters the higher temperature formation targeted for fracturing. The increased viscosity facilitated by this invention will help reduce fluid loss into the formation, outside the intended fracture and further assist in proppant transport efficiency into the fracture.

Embodiments of the present invention teach the application of such thermo-thickening and/or thermo-responsive hydrogels and/or thermo-thickening and/or thermo-responsive polymer solutions as additives to LC pills. A LC pill works by prohibiting loss of fluid into unconsolidated geological features, i.e. fractures, fissures, caverns, or other areas of high permeability, so that fluid is retained in the wellbore and not lost to said unconsolidated geological features, fractures, fissures, caverns, or other areas of high permeability. Lost circulation causes reduction in the fluid column and therefore a reduction in the hydrostatic pressure exerted on the formation, and, if severe enough, can cause unwanted fluid invasion from an undesired zone or even catastrophic loss of well control. The invention disclosed herein would add to a LC pill's efficiency by forming a self-associating gel that will act to decrease permeability and seal the formation's imperfections against any further fluid loss.

Embodiments of the present invention teach polymers that impart a rheological profile that is generally flat with respect to variations in the shear-rate and temperature environment in which drilling fluids, RDF's, FLC pills, frac fluids, and LC pills are deployed. The rheological properties of a fluid can change as it is pumped into the wellbore and subjected to shear forces and exposed to higher subsurface temperatures. Fluids that are used in the petroleum industry typically decrease in viscosity with either higher shear forces and/or higher temperatures and potentially decrease the efficiency for which the fluid was designed. The invention disclosed herein can be added to these fluids in an amount sufficient to increase the fluid viscosity as the fluid temperature is increased, but not in an amount sufficient to form a gel. In this manner, the fluid would retain largely the same rheological properties over a broad range of temperatures and shear rates.

Embodiments of the present invention teach the process of producing a high performance filtercake through the application of thermo-thickening and/or thermo-responsive hydrogels and/or thermo-thickening and/or thermo-responsive polymer solutions. The function of a filter cake is to form a layer of low permeability on the surface of the wellbore to prevent loss of fluid into the formation while drilling. An inadequate filter cake can result in seepage of drilling mud that can cause fluid loss, lost circulation, and/or formation damage leading to reduced zonal production. The invention disclosed herein will aid in the function of a filter cake by migrating to the surface of the wellbore and increasing in viscosity, forming a protective gel layer due to the higher geothermal temperatures at the edge of the wellbore, thereby acting to further minimize fluid loss to the formation.

Embodiments of the present invention teach the process of achieving fluid diversion through the application of thermo-thickening and/or thermo-responsive hydrogels and/or thermo-thickening and/or thermo-responsive polymer solutions. The purpose of fluid diversion is to stimulate zones of low permeability while diverting said stimulating fluid away from high permeability zones. These fluids operate by temporarily blocking the permeability of the zones more likely to take the fluid and allow stimulation of zones that require higher production rates. The invention disclosed herein will act as a diverting agent by flowing into areas of higher permeability where the temperature is greater than the interior of the wellbore. This increase in temperature will cause the fluid to increase viscosity and gel, thereby reducing the zone's permeability. This allows a stimulating fluid to target zones of low permeability and a subsequent drop in pH would then break the gel and restore the productivity of the formerly blocked zone.

At the end of the use of thermo-thickening and/or thermo-responsive hydrogels and/or thermo-thickening and/or thermo-responsive polymer solutions, a chemical break therein is also desired. Embodiments of the present invention teach that this chemical break may be due to the application of an external chemical. U.S. Pat. Nos. 4,741,401 and 3,938,594 disclose a number of oxidizing agents, acids, micellar solutions, and surfactants for application as external breakers suitable for degrading thermo-thickening and thermo-responsive hydrogels and thermo-thickening and thermo-responsive polymers. U.S. Pat. Nos. 4,741,401 and 3,938,594 are therefore incorporated herein in their entirety.

Embodiments of the present invention teach that this chemical break may be due to the natural breakdown of chemically weak segments deliberately engineered into said thermo-thickening and/or thermo-responsive hydrogels and/or thermo-thickening and/or thermo-responsive polymers. As one example of such deliberate engineering of chemically weak segments into the highly water-soluble backbone of a thermo-responsive polymer, consider the reaction of vinyl hydrogen carbonate with a vinyl alcohol oligomer to form a vinyl-carbonate-terminated oligo-vinyl alcohol as illustrated in Structure (1) below:

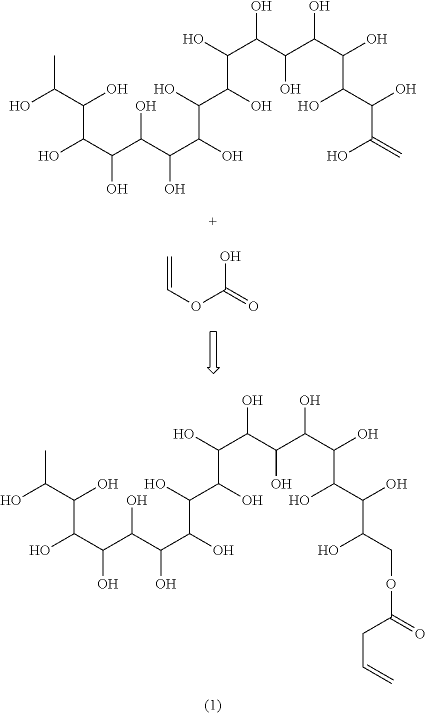

Said vinyl-carbonate-terminated oligo-vinyl alcohol “monomers” such as, for example, structure (1) can subsequently be further polymerized to form a highly water-soluble backbone of a thermo-responsive polymer with chemically weak segments deliberately engineered therein as illustrated in Structure (2) below:

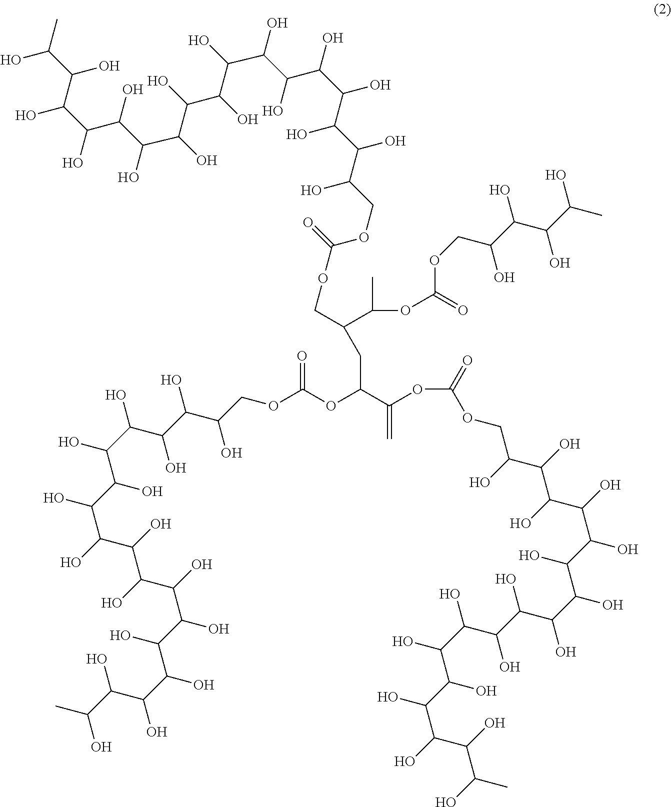

Finally, linear or non-linear linkages having relatively low LCST's can be grafted onto the highly water-soluble backbone structures like Structure (2) to convert them into suitable thermo-responsive polymers.

Another example in accordance with the present invention teaching that this chemical break may be due to the natural breakdown of chemically weak segments deliberately engineered into said thermo-thickening and/or thermo-responsive hydrogels and/or thermo-thickening and/or thermo-responsive polymers is illustrated with the following structure:

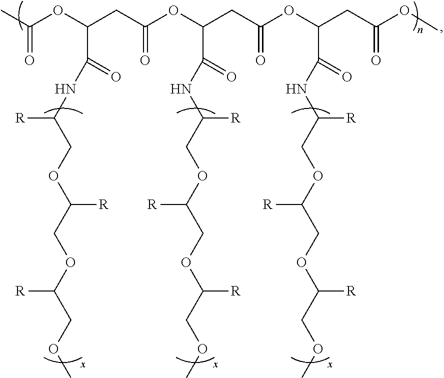

where R=H or CH₃. By allowing the chemically weak ester linkages along the backbone of this polymer to naturally degrade, the thermo-thickening or thermo-responsive character of the polymer will gradually cease to be exhibited.

In another embodiment of the present invention, an esterase or a combination of an esterase and an amidase enzyme may be applied to a structure such as that illustrated above to relatively rapidly break down the structure and cause the thermo-thickening or thermo-responsive character of the polymer to cease to be exhibited.

Embodiments of the present invention teach that this chemical break may be due to the activation of a previously inactive internal breaker chemical. The invention disclosed herein, whose temperature-sensitive rheological responses may no longer be required, can be diminished through hydrolysis of the grafted side-chains or through hydrolysis of the water soluble backbone polymer, such as the hydrolysis of amide functionalities to carboxylates. These carboxylates would be sensitive towards multivalent cations that may be present in the carrier fluid or brine and induce chelation, gel-structure destruction, and potentially denaturation of the polymer. Another method of breaking the gel properties of the invention disclosed herein can be accomplished by lowering the pH to below 4 by a slow release or delayed acid. This acid can be generated through ester hydrolysis, such as lactide or polylactic acid, or through the use of an encapsulated acid. The acid would serve to protonate a water-soluble polymer backbone containing carboxylate groups to form a less soluble carboxylic acid moiety that will drive dehydration, shrinking, and potentially denaturation of the polymer.

In some embodiments, the present invention teaches thermo-thickening and/or thermo-responsive polymers that are graft copolymers comprising a water-soluble portion to which non-linear linkages are grafted. An example in accordance with the present invention teaching a thermo-thickening and/or thermo-responsive hydrogel and/or thermo-thickening and/or thermo-responsive polymer comprising a linear portion or backbone and with non-linear linkages coming off of it is illustrated with the following structure:

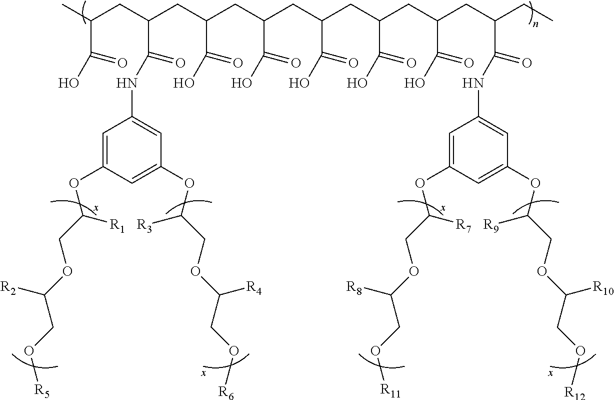

where R₁ through R₁₂ are independently selected from H, CH₃, C₂ to C₁₈ alkyl groups, C₆ to C₂₅ aryl groups, C₇ to C₂₆ alkaryl groups, or C₇ to C₂₆ aralkyl groups.

In some embodiments, the present invention teaches such graft copolymers comprising a water-soluble portion which may be either linear or non-linear to which linear or non-linear linkages are grafted. An example in accordance with the present invention teaching a thermo-thickening and/or thermo-responsive hydrogel and/or thermo-thickening and/or thermo-responsive polymer comprising a non-linear portion or backbone and with non-linear linkages coming off of it is illustrated with the following structure:

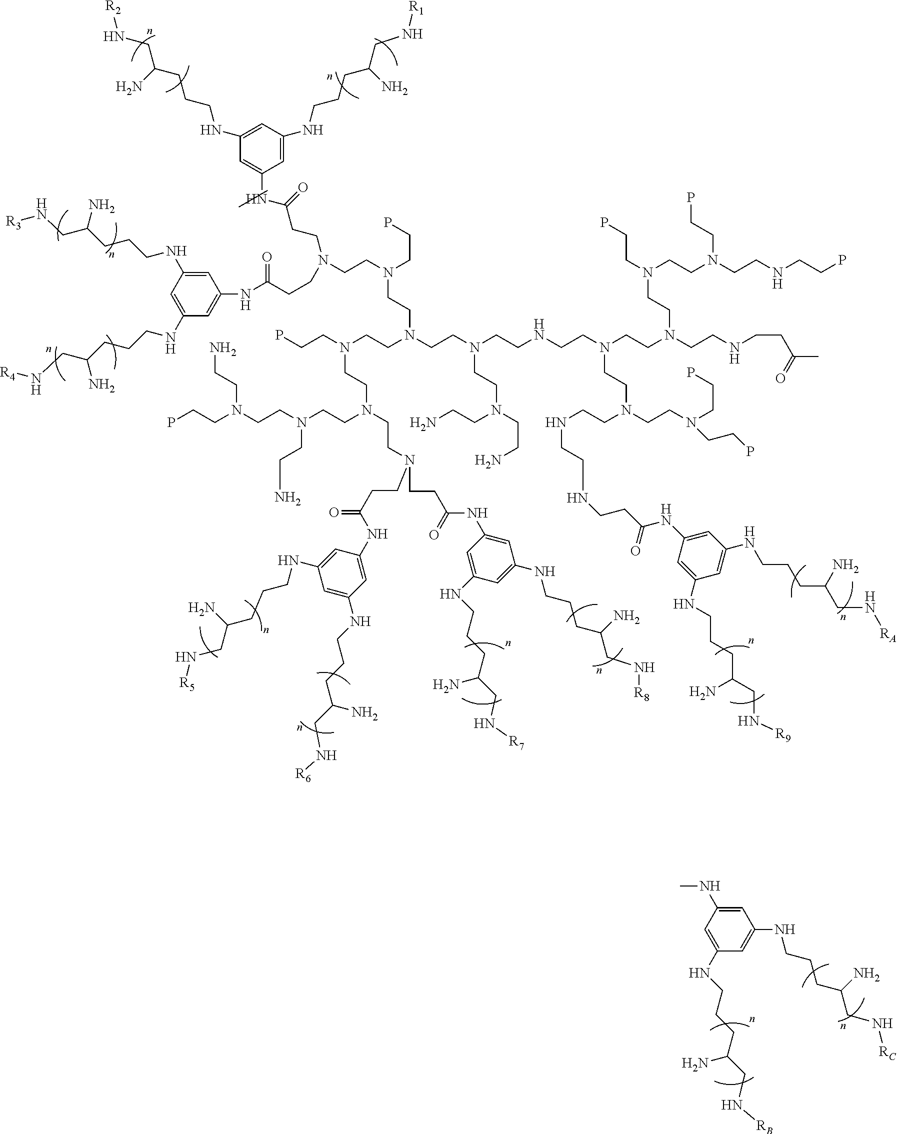

where R₁ through R₉, R_{A}, R_{B}, and R_{C} are independently selected from H, CH₃, C₂ to C₁₈ alkyl groups, C₆ to C₂₅ aryl groups, C₇ to C₂₆ alkaryl groups, or C₇ to C₂₆ aralkyl groups, and where the groups indicated by the letter “P” may be continuations of the polymer chain with additional azirane (ethylenimine) monomer groups, oligoazirane groups, polyazirane groups, or similar groups (azirane monomer groups, oligoazirane groups, polyazirane groups) with non-linear side chains grafted onto them.

In some embodiments, the present invention teaches thermo-thickening and/or thermo-responsive polymers that are graft copolymers having an overall structure that is a much more complex than the comb-like structure, with a non-linear portion or backbone and with linear linkages coming off of it. An example of such a thermo-thickening and/or thermo-responsive hydrogel and/or thermo-thickening and/or thermo-responsive polymer comprising a non-linear portion or backbone and with linear linkages coming off of it is illustrated with the following structure:

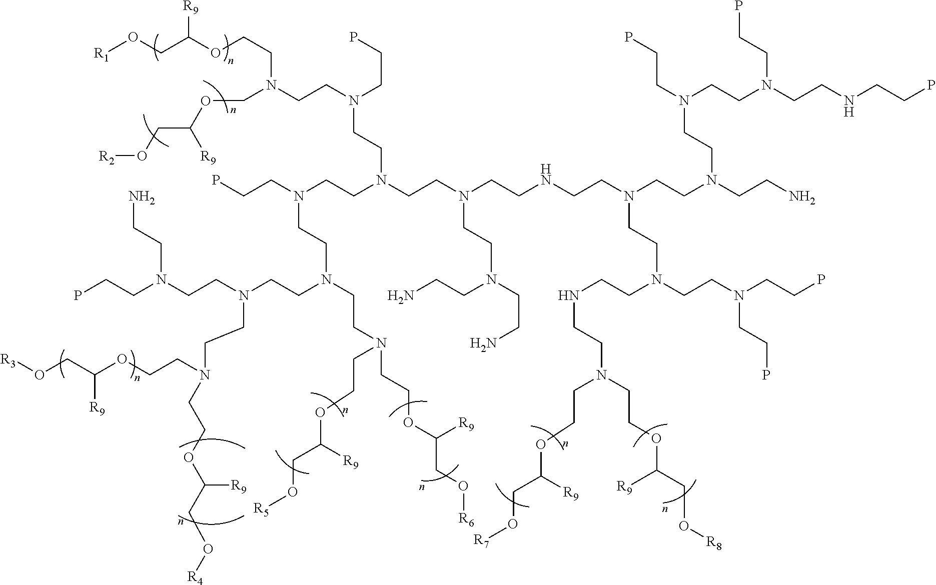

where R₁ through R₇, and R₈ are independently selected from H, CH₃, C₂ to C₁₈ alkyl groups, C₆ to C₂₅ aryl groups, C₇ to C₂₆ alkaryl groups, or C₇ to C₂₆ aralkyl groups, R₉=H or CH₃, and where the groups indicated by the letter “P” may be continuations of the polymer chain with additional azirane (ethylenimine) monomer groups, oligoazirane groups, polyazirane groups, or similar groups (azirane monomer groups, oligoazirane groups, polyazirane groups) with linear side chains grafted onto them.

An example in accordance with the present invention teaching a thermo-thickening and/or thermo-responsive hydrogel and/or thermo-thickening and/or thermo-responsive polymer comprising a non-linear portion or backbone and with non-linear linkages coming off of it is illustrated with the following structure:

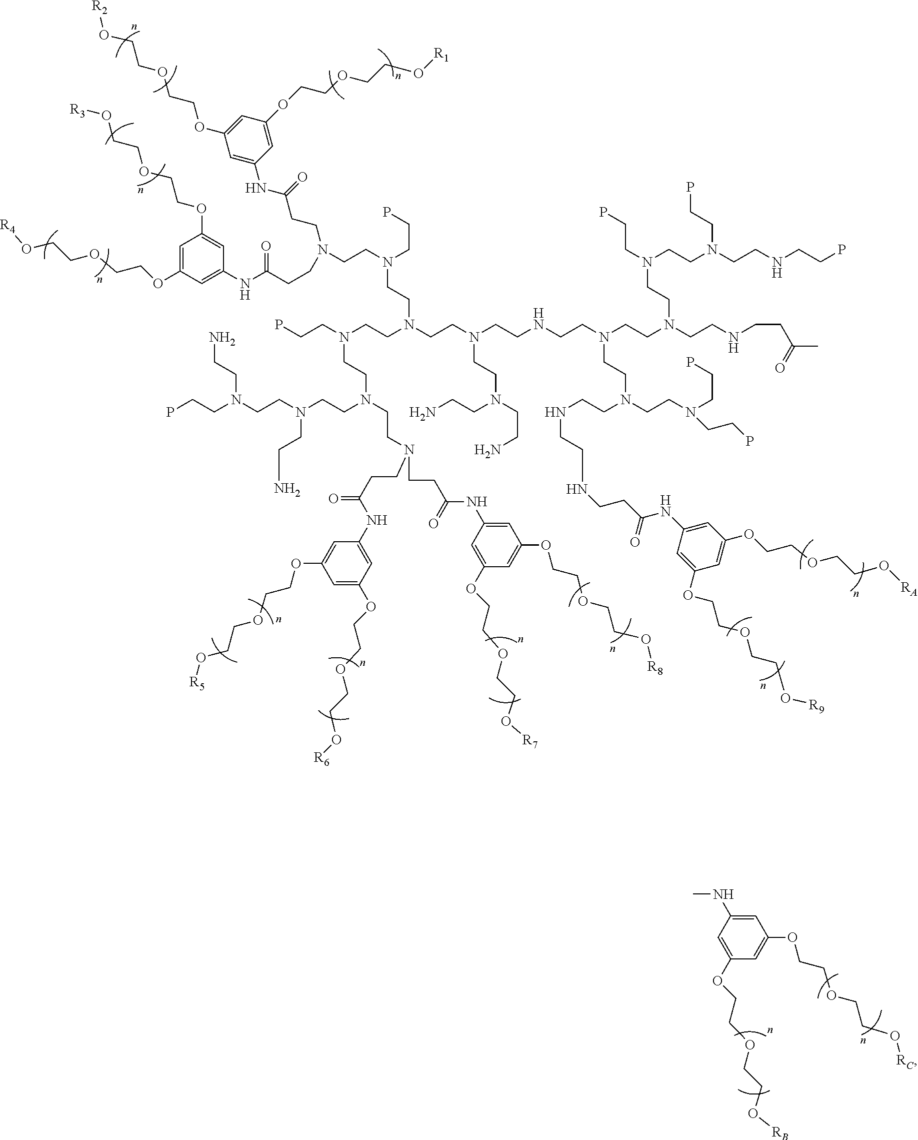

where R₁ through R₉, R_{A}, R_{B}, and R_{C} are independently selected from H, CH₃, C₂ to C₁₈ alkyl groups, C₆ to C₂₅ aryl groups, C₇ to C₂₆ alkaryl groups, or C₇ to C₂₆ aralkyl groups, and where the groups indicated by the letter “P” may be continuations of the polymer chain with additional azirane (ethylenimine) monomer groups, oligoazirane groups, polyazirane groups, or similar groups (azirane monomer groups, oligoazirane groups, polyazirane groups) with non-linear side chains grafted onto them.

In some embodiments, the present invention teaches such graft copolymers having linear or non-linear linkages coming off of it such that said pendant linkages possess thermo-stimulatable structure or structures that may form a microphase in response to changes in temperature. The thermal response exhibited by the invention disclosed herein is caused by the thermally-induced aggregation or association of the graft side-chains. These side chains consist of polymers that exhibit a lower critical solution temperature (LCST) that cause a thermally-induced change in their hydrophilic/hydrophobic character. Above the LCST, these side-chain moieties are no longer as soluble in the carrier solution and form self-aggregated microphases or microdomains. Examples of polymers exhibiting LCST's include, but are not limited to, cellulosic polymers, polyalkoxylates, and alkylacrylamides.

Embodiments of the present invention have been illustrated up to this point with respect to a limited number of descriptions involving polymers that are graft copolymers comprising a water-soluble portion to which linkages are grafted at numerous locations along the length of said water-soluble portion wherein said side chains consist of polymers that exhibit an LCST that causes a thermally-induced change in their hydrophilic/hydrophobic character, eliciting a thermal response caused by the thermally-induced aggregation or association of the graft side-chains. Above the LCST, these side-chain moieties are no longer as soluble in the carrier solution and form self-aggregated microphases or microdomains. Examples of polymers exhibiting LCST's include, but are not limited to, cellulosic polymers, polyalkoxylates, and alkylacrylamides. Those skilled in the art, having benefit of this disclosure, will appreciate that other embodiments can be devised which do not depart from the scope of the invention and which involve no grafting, but instead involve continual copolymerization process. Said copolymerization process may begin with a homo-oligomerization or homopolymerization of a single relatively water-soluble monomer or, optionally, said copolymerization process may begin with a co-oligomerization or copolymerization of two, three, or more relatively water-soluble monomers. Then before said beginning homo-oligomerization, homopolymerization, co-oligomerization, or copolymerization are completed, new monomers or oligomers are introduced to take part in the completion of the copolymerization process. Said new monomers introduced to take part in the completion of the copolymerization process may include, but are not limited to cellulosic monomers, oligomers, or polymers, alkoxylate monomers, oligomers, or polymers, and alkylacrylamide monomers, oligomers, or polymers. Said copolymerization process begun with a relatively water-soluble monomer or with two, three, or more relatively water-soluble monomers, and continued when new monomers are introduced to take part in the completion of the copolymerization process may yield structures quite similar to those mentioned as examples in paragraphs [0010] through [0031] above, but will have resulted from a continual copolymerization process rather than from a first polymerization or copolymerization process followed by a grafting process.

### EXAMPLES

### Example 1

### Poly(Acrylic Acid)/Poly(Ethylene Glycol)

This example describes the process for the preparation of poly(acrylic acid) modified with a thermally responsive moiety. Thermally responsive poly(acrylic acid) was synthesized by the coupling reaction of an amine-terminated, methyl-protected poly(oxyalkylate) (Aldrich, methoxypolyethylene glycol amine, MW-5,000) on carbonyl groups of poly(acrylic acid) (Aldrich, MW-500,000) in an aprotic solvent, N-methyl pyrrolidone, in the presence of dicyclohexylcarbodiimide. Poly(acrylic acid) (3.03 g, 6×10⁻⁶ moles) was dissolved in 65 mL N-methylpyrrolidone in a 250 mL round-bottom flask and heated to 60° C. Methoxypolyethylene glycol amine (1.57 g, 3.14×10⁻⁴ moles) was dissolved in 25 mL N-methylpyrrolidone and added to the flask with stirring. Dicyclohexylcarbodiimide (0.206 g, 1×10⁻³ moles) was dissolved in 10 mL N-methylpyrrolidone and added dropwise to the flask over 15 minutes and kept at 60° C. with stirring for 24 hours. After being cooled to room temperature, the polymer was collected by filtration and washed with N-methylpyrrolidone (50 mL) and methanol (3×50 mL) and dried at 100° C. overnight in a vacuum oven.

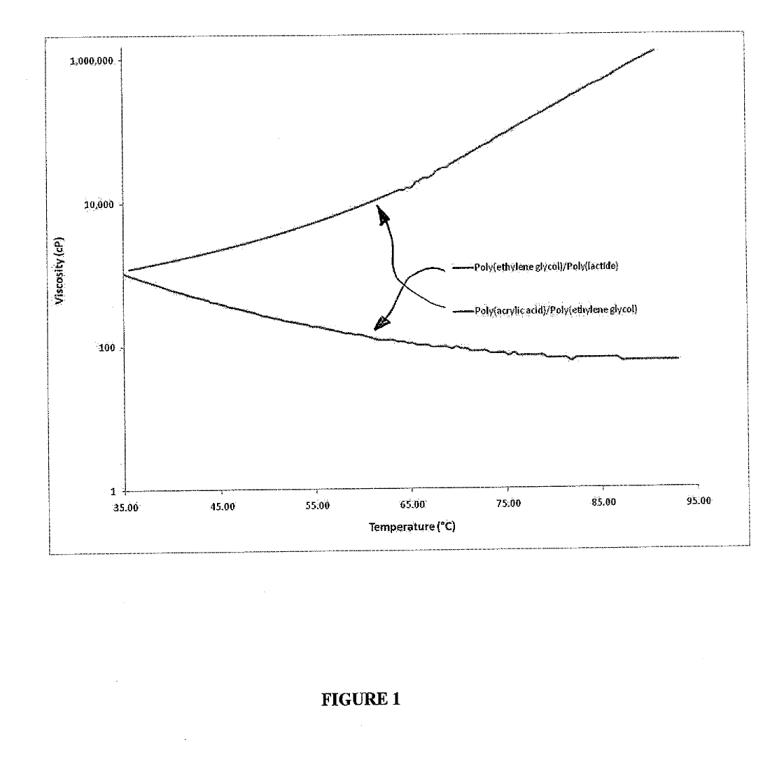

The poly(acrylic acid)/poly(ethylene glycol) product was dissolved in a 14% potassium carbonate solution to afford a 4% polymer solution. This solution was analyzed on a Brookfield DV-II+ Pro viscometer using an LV4 spindle. The viscosity was measured over a temperature range of 25° C. to 100° C., resulting in a viscosity increase on the order of 10³ to 10⁴, as illustrated with the upper curve in FIG. 1.

### Example 2

### Poly(Ethylene Glycol)/Poly(Lactide)

This example describes the preparation of a poly(ethylene glycol)/poly(lactide) copolymer. The poly(ethylene glycol)/poly(lactide) copolymer was synthesized through the use of tin(2-ethylhexanoate) as a catalyst to polymerize L-lactide (Purac) onto poly(ethylene glycol) (Sigma, MW-8000). Poly(ethylene glycol) (100 g, 0.125 moles) was heated to 150° C. with stirring for 3 hours under vacuum, after which tin(2-ethylhexanoate) (0.06 g, 1.48×10⁻⁴) was added and stiffing continued for 15 minutes. The temperature was reduced to 130° C. and L-lactide (120 g, 0.833 moles) was added to the flask and stiffing under vacuum was resumed for 15 minutes. The flask was then purged with nitrogen and the polymerization allowed to progress for 24 hours. After the permitted time, the melt was transferred to a bottle to cool.

The poly(ethylene glycol)/poly(lactide) polymer product was dissolved in water to afford a 24% solution. This solution was analyzed in the same manner as described in Example 1, but did not perform as well as some of the embodiments of the present invention, as illustrated with the lower curve in FIG. 1.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A drilling fluid, comprising:
an aqueous working fluid; and
a gelling agent disposed in the working fluid, the gelling agent having a polymer backbone and thermo-thickening functional groups extending from the polymer backbone, wherein the polymer backbone has a molecular structure that contributes to water solubility of the gelling agent.

2. The drilling fluid of claim 1, wherein the polymer backbone is linear, water-soluble poly(acrylic acid) and the functional groups are linear poly(ethylene oxide).

3. The drilling fluid of claim 1, wherein the polymer backbone is linear, water-soluble poly(acrylamide) and the functional groups are poly(ethylene oxide-co-propylene oxide).

4. The drilling fluid of claim 1, wherein the polymer backbone is a polyester.

5. The drilling fluid of claim 1, wherein the polymer backbone includes vinyl-carbonate-terminated oligo-vinyl alcohol.

6. The drilling fluid of claim 5, characterized in that the thermo-thickening functional groups become less water-soluble and self-aggregate into microdomains as the temperature increases, wherein the self-aggregation causes an increase in the viscosity of the gelling agent.

7. The drilling fluid of claim 6, wherein the microdomains of self-aggregated functional groups form a 3-dimensional, self-associated/crosslinked gel network.

8. The drilling fluid of claim 1, wherein the polymer forms a hydrogel.

9. The drilling fluid of claim 1, wherein the polymer backbone includes at least one chemically weak segment for facilitating a chemical break.

10. The drilling fluid of claim 1, wherein the polymer backbone includes an ester linkage for facilitating a chemical break.

11. The drilling fluid of claim 1, wherein the aqueous working fluid is selected from a reservoir drilling fluid, fluid loss control pill, hydraulic fracturing fluid, and a lost circulation pill.

12. The drilling fluid of claim 1, wherein the polymers impart a rheological profile that is generally flat with respect to variations in the shear-rate and temperature environment in which the polymers are deployed.

13. A method, comprising:
introducing an aqueous drilling fluid into a wellbore, wherein the aqueous drilling fluid includes a thermo-thickening composition having a polymer backbone and thermo-thickening functional groups extending from the polymer backbone, wherein the polymer backbone has a molecular structure that contributes to water solubility of the gelling agent.

14. The method of claim 13, wherein the polymer backbone is linear, water-soluble poly(acrylic acid) and the functional groups are linear poly(ethylene oxide).

15. The method of claim 13, wherein the polymer backbone is linear, water-soluble poly(acrylamide) and the functional groups are poly(ethylene oxide-co-propylene oxide).

16. The method of claim 13, wherein the polymer backbone is a polyester.

17. The method of claim 13, wherein the polymer backbone includes vinyl-carbonate-terminated oligo-vinyl alcohol.

18. The method of claim 17, characterized in that the thermo-thickening functional groups become less water-soluble and self-aggregate into microdomains as the temperature increases, wherein the self-aggregation causes an increase in the viscosity of the gelling agent.

19. The method of claim 18, wherein the microdomains of self-aggregated functional groups form a 3-dimensional, self-associated/crosslinked gel network.

20. The method of claim 13, wherein the polymer forms a hydrogel.

21. The method of claim 13, wherein the polymer backbone includes at least one chemically weak segment for facilitating a chemical break.

22. The method of claim 21, wherein the at least one chemically weak segment is an ester.

23. The method of claim 22, further comprising:
introducing an esterase enzyme into contact with the drilling fluid to break down the polymer and reduce the thermo-thickening character of the polymer.

24. The method of claim 13, further comprising:
introducing a chemical into the wellbore to hydrolyze the functional groups or the polymer backbone to reduce the extent of thermo-thickening.

25. The method of claim 13, further comprising:
lowering the pH of the aqueous drilling fluid to a pH less than 4 to reduce the extent of thermo-thickening.

26. The method of claim 13, wherein the aqueous drilling fluid is selected from a reservoir drilling fluid, fluid loss control pill, hydraulic fracturing fluid, and a lost circulation pill.

27. The method of claim 13, wherein the polymer is present within the aqueous drilling fluid in a sufficient concentration to impart the aqueous drilling fluid with a rheological profile that is generally flat with respect to variations in shear-rate and temperature within the wellbore.
